(19) United States
(12) Patent Application Publication
(10) Pub. No.: US 2020/0386565 A1
(43) Pub. Date: Dec. 10, 2020

(54) PREDICTING PRIME LOCATIONS FOR MOBILE ASSETS

(71) Applicant: INTERNATIONAL BUSINESS MACHINES CORPORATION, Armonk, NY (US)

(72) Inventors: Rajendra Rao, Los Gatos, CA (US); Rajesh Phillips, Bangalore (IN); Manisha Sharma Kohli, New Delhi (IN); Puneet Sharma, Bangalore (IN); Vijay Ekambaram, Chennai (IN)

(21) Appl. No.: 16/433,047

(22) Filed: Jun. 6, 2019

(51) Int. Cl. G01C 21/34; G01C 21/10; G01C 21/00; G01C 21/36; H04W 4/02

(52) U.S. Cl. CPC G01C 21/3484; G01C 21/10; H04W 4/025; G01C 21/3641; G01C 21/005

(57) ABSTRACT

A method, computer system, and a computer program product for predicting one or more travel paths for one or more mobile assets is provided. The present invention may include retrieving a set of input data. The present invention may then include predicting one or more spatio-temporal user profile flows based on the set of past user trajectory data and the plurality of user interests. The present invention may also include correlating the predicted one or more spatio-temporal user profile flows with the one or more mobile assets. The present invention may then include determining potential travel paths in one or more routes associated with a geographical region for one or more mobile assets and halting points for one or more mobile assets.

### BACKGROUND

The present invention relates generally to the field of computing, and more particularly to asset location determination.

Mobile assets (e.g., moving showrooms, mobile assets, mobile trucks, mobile exhibition trucks, food trucks, promotion trucks, moving stages) may be useful and may serve as an effective outdoor promotion tool, enabling brands to reach different customers in different hotspots. Mobile assets may be ideal for temporary stores (e.g., pop-up stores, short term stores) and product launches. Mobile assets have also experienced a surge in popularity in various overseas markets. By shopping in mobile assets, guests (i.e., guests) may have a unique customer experience. Additionally, mobile assets, unlike traditional stores, may travel to numerous locations, promoting multiple brands in high rental areas with low costs, while continuing to promote to a target segment. Therefore, mobile assets may be able to utilize more flexible marketing plans and initiatives with a high level of efficiency.

### SUMMARY

Embodiments of the present invention disclose a method, computer system, and a computer program product for predicting one or more travel paths for one or more mobile assets. The present invention may include retrieving a set of input data, wherein the retrieved set of input data includes a set of input user data and a set of input mobile asset data, wherein the retrieved set of input user data includes a set of past user trajectory data and a plurality of user interests. The present invention may then include predicting one or more spatio-temporal user profile flows based on the set of past user trajectory data and the plurality of user interests. The present invention may also include correlating the predicted one or more spatio-temporal user profile flows with the one or more mobile assets. The present invention may further include determining one or more potential travel paths in one or more routes associated with a geographical region for one or more mobile assets and one or more halting points for one or more mobile assets.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2A illustrates an asset device environment according to at least one embodiment;

FIG. 2B illustrates a user device environment according to at least one embodiment;

FIG. 3 is an operational flowchart illustrating a process for predicting a prime location for a mobile asset according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

The following described exemplary embodiments provide a system, method and program product for predicting one or more potential travel paths for one or more mobile assets. As such, the present embodiment has the capacity to improve the technical field of asset location determination by predicting the potential travel paths with higher visible parking spaces (i.e., halting points) for mobile assets. More specifically, a location prediction program may profile spatio-temporal user flows from past user trajectory data, and may further enable spatio-temporal runtime profile matching between mobile assets and predicted user profile flows in certain routes in a geographical region from location based social media analysis. The location prediction program may then correlate the mobile assets matched spatio-temporal user flows with aerial image segmentation inferences. The location prediction program may then fuse the data generated from the above steps to predict the prime locations suitable to park or halt the mobile assets, as well as having high matching between the asset profiles associated with the mobile assets and passers-by.

As previously described, mobile assets (e.g., moving showrooms, mobile assets, mobile trucks, mobile exhibition trucks, food trucks, promotion trucks, moving stages) may be useful and may serve as an effective outdoor promotion tool, enabling brands to reach different customers in different hotspots. Mobile assets may be ideal for temporary stores (e.g., pop-up stores, short term stores) and product launches. Mobile assets have also experienced a surge in popularity in various overseas markets. By shopping in mobile assets, guests (i.e., guests) may have a unique customer experience. Additionally, mobile assets, unlike traditional stores, may travel to numerous locations, promoting multiple brands in high rental areas with low costs, while continuing to promote to a target segment. Therefore, mobile assets may be able to utilize more flexible marketing plans and initiatives with a high level of efficiency.

Current approaches in asset location determination fail to address location predictions for improved visibility of a mobile asset by predicting various temporal profile aspects in various routes located in a geographical region or area (including cities, suburbs, rural areas). In addition, currently data-driven analytics may be used for permanent store location recommendations. However, the users may commute to various places in a single day for various official or personal purposes. Therefore, that location profile may vary highly based on the temporal flow of people (e.g., inward as well as outward) in the area which is very highly critical in mobile asset location decision making. As such, since mobile assets are highly temporal, the temporal aspect of location profile may be considered for effective predictions.

Furthermore, current approaches on spatio-temporal inward/outward flow of users and how spatio-temporal inward/outward flow matches with asset profile is not considered for mobile asset location prediction. Current approaches traditionally leverage existing data (e.g., census data, survey data, foot traffic data) for retail store location prediction, as well as utilizing data sources, such as geolocation internet protocol (geoIP) address (i.e., locating computer terminal's geographical location by identifying the computer terminal's IP address), tagged data sources (i.e., tracking information about user profile based on web-surfing locations) and social media (i.e., leverages data from social media applications for location profiling). Therefore, it may be advantageous to, among other things, automatically suggest the travel path for each of the mobile assets and halting locations at various time points in a data-driven approach in which a region identification/identifier (ID), number of mobile assets, an asset profile and a date may be utilized.

According to at least one embodiment, the location prediction program may predict potential travel paths with higher visible halting points for mobile assets. The location prediction program may profile spatio-temporal user flows from past user trajectory data (e.g., movement of the user within a certain period of time) and various dimensions associated with the interests of the user (i.e., user interests or user features) (e.g., fashion, gourmet cooking, sports, or any attributes that include any interests associated with the user) by detecting the user profile based on the trajectory movements across various mobile assets. Since each mobile asset has an asset profile, the location prediction program may utilize the data collected to map the user profiles. For example, the user traveling more to mobile assets that sell silk saree are traditional dress lovers. Such association of the data is then utilized to profile user flow points.

According to at least one embodiment, the location prediction program may enable spatio-temporal runtime profile matching between mobile assets and predicted user profile flows in a geographical region (e.g., city) route from location based on social media analysis. The mobile assets matched with spatio-temporal user flows may be correlated with aerial image segmentation inferences. Then, the location prediction program may then fuse the data generated to predict the prime locations suitable enough to park or halt the mobile assets, as well as having high matching between the asset profile associated with the mobile asset and the passers-by.

According to at least one embodiment, the location prediction program may evaluate several parameters to suggest temporal mobile locations, such as spacious parking space of the mobile assets that may not hinder traffic (or may be considered a prime location), asset profile and optimizing the path of the mobile assets. The asset profile associated with the mobile assets may have a high correlation with the users passing-by at a particular location. Since the mobile asset may travel to different locations in a single day, the location prediction program may optimize the travel path to gather overall attraction and promotion.

The present embodiment may include profiling users, route discovery, satellite segmentation, spatio-temporal user profile analysis and asset location prediction to predict the potential travel path with higher visible halting points for mobile assets.

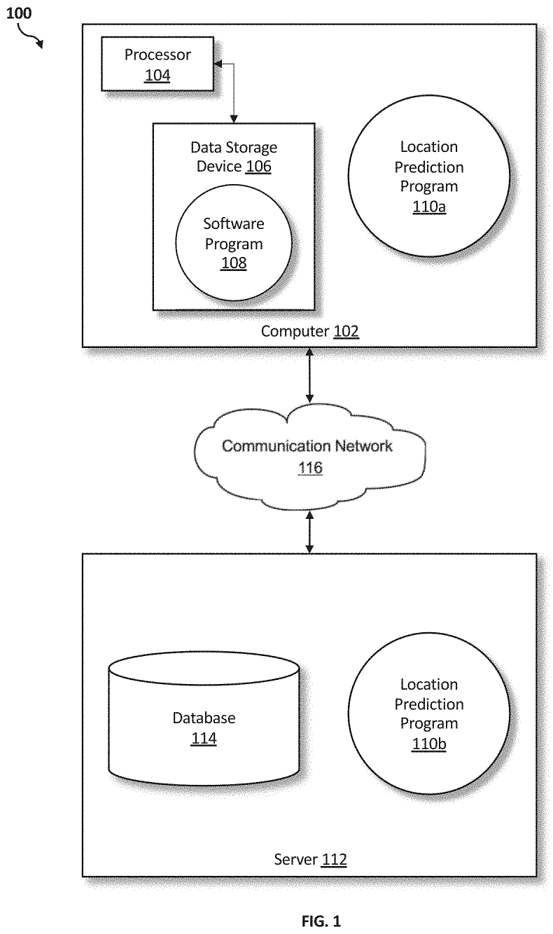

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a location prediction program 110a. The networked computer environment 100 may also include a server 112 that is enabled to run a location prediction program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

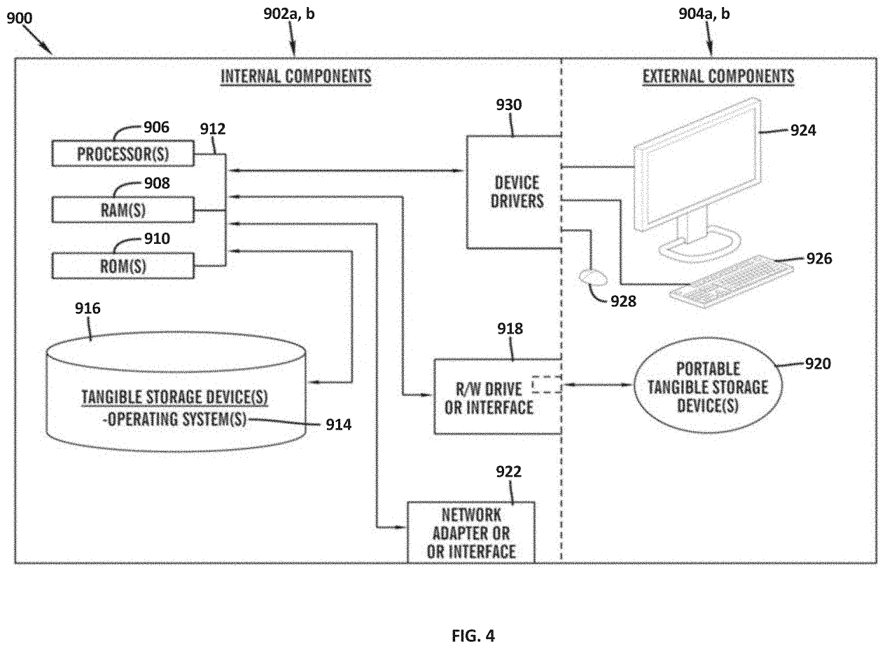

The client computer 102 may communicate with the server computer 112 via the communications network 116. The communications network 116 may include connections, such as wire, wireless communication links, or fiber optic cables. As will be discussed with reference to FIG. 4, server computer 112 may include internal components 902a and external components 904a, respectively, and client computer 102 may include internal components 902b and external components 904b, respectively. Server computer 112 may also operate in a cloud computing service model, such as Software as a Service (SaaS), Analytics as a Service (AaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a wearable device, an augmented reality device, a virtual reality device a telephone, a personal digital assistant, a netbook, a laptop computer, a tablet computer, a desktop computer, or any type of computing devices capable of running a program, accessing a network, and accessing a database 114. According to various implementations of the present embodiment, the location prediction program 110a, 110b may interact with a database 114 that may be embedded in various storage devices, such as, but not limited to a computer/mobile device 102, a networked server 112, or a cloud storage service.

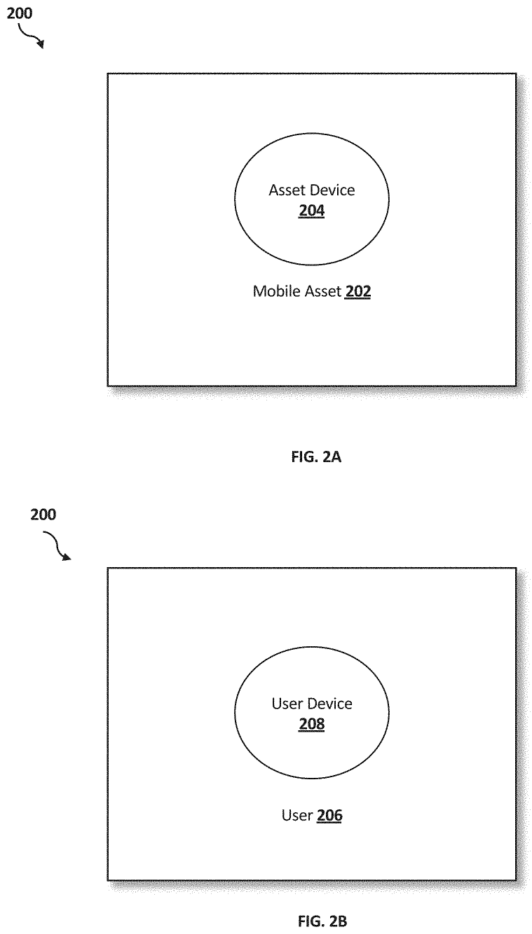

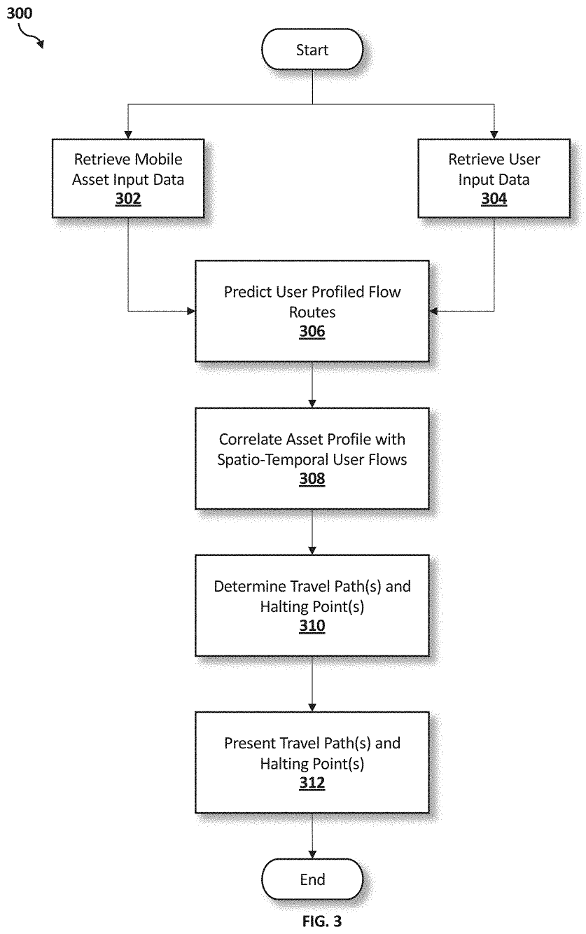

According to the present embodiment, a user using a client computer 102 or a server computer 112 may use the location prediction program 110a, 110b (respectively) to predict a potential travel path with higher visible halting points for mobile assets. The location prediction method is explained in more detail below with respect to FIGS. 2A, 2B and 3.

Referring now to FIG. 2A, an exemplary asset device environment 200 in accordance with one embodiment is depicted. As shown, the asset device environment 200 includes a mobile asset 202. The mobile asset 202 may, for example, include moving showrooms, mobile assets, mobile trucks, mobile exhibition trucks, food trucks, promotion trucks, and moving stages. The asset device 204 (e.g., computer 102) may be located within the mobile asset 202. The specific location of the asset device 204 within the mobile asset 202 may depend on the specific manufacturer of the mobile asset 202 associated with the asset device 204, or the preference of a representative associated with the mobile asset 202. The representative may, for example, include an owner of the mobile asset, an authorized employee or agent of the mobile asset 202.

Referring now to FIG. 2B, an exemplary user device environment 200 in accordance with one embodiment is depicted. As shown, the user device environment 200 may include a user 206, who is a person that frequents the mobile asset 202, and/or a passer-by who encounters the mobile asset 202 during the daily pattern of the user 206. The user device 208 (e.g., computer 102) may be located on, or within close proximity to, the user 206.

Referring now to FIG. 3, an operational flowchart illustrating the exemplary prime location prediction process 300 used by the location prediction program 110a, 110b according to at least one embodiment is depicted.

At 302, input mobile asset data is retrieved. Input mobile asset data (i.e., data associated with the mobile asset 202) may be retrieved automatically, manually with input from a mobile asset representative via a graphical user interface (GUI), or an application downloaded onto the asset device 204.

Utilizing a software program 108 on the asset device 204, input mobile asset data may be retrieved as input into the location prediction program 110a, 110b via the communication network 116. The input mobile asset data may, for example, include a region identification/identifier (region ID), an asset profile, a date, or other data associated with the mobile asset 202. In an embodiment, the location prediction program 110a, 110b may retrieve input mobile asset data corresponding with multiple mobile assets 202 associated with a single asset profile, for example, if the asset profile is a franchise that includes multiple mobile assets 202. In some embodiments, the location prediction program 110a, 110b may retrieve the number of mobile assets 202 that may be permitted by law (e.g., based on local ordinances, or statutes) in a particular geographic region or a particular route.

The location prediction program 110a, 110b may retrieve the region ID associated with the current location of the mobile asset 202 from traditional location profiling for region ID from census data, traffic data, and survey data. The region ID may, for example, include the name of the region, street number, longitude/latitude coordinates, or popular names associated with the region that may be utilized by the location prediction program 110a, 110b to identify the region and any surrounding or neighboring areas. In conjunction with the region ID, the location prediction program 110a, 110b may extract events occurring in the geographical region (e.g., city, suburbs, rural areas) from social media analysis performed by an external engine. The external engine may then transmit the analysis from various social networks to the location prediction program 110a, 110b.

The asset profile may be previously created by the mobile asset representative in which the pertinent information may be manually entered into the location prediction program 110a, 110b, or pertinent information (e.g., information related to the applicable fields for the asset profile) may be transmitted, via the communications network 116, into the location prediction program 110a, 110b. The asset profile may, for example, include the name of the mobile asset 202, the type of users 206 that frequent the mobile asset 202, and the type of services provided by the mobile asset 202. In an embodiment, the location prediction program 110a, 110b may include a website, contact information and any user reviews associated with the mobile asset 202.

The asset profile may then be stored in an asset profile database (e.g., database 114) associated with the location prediction program 110a, 110b. As such, the mobile asset representative may, at a later date, provide the name associated with the mobile asset 202 and the location prediction program 110a, 110b may retrieve the associated asset profile from the asset profile database.

In at least one embodiment, for previously provided input mobile asset data, the location prediction program 110a, 110b may prompt (e.g., via dialog box) the mobile asset representative to indicate whether the input mobile asset data has changed by, for example, selecting the “No” button or “Yes” button located at the bottom of the dialog box. If the mobile asset representative clicks the “No” button, then the dialog box may disappear. If the mobile asset representative clicks the “Yes” button, then another dialog box may appear in which the mobile asset representative may manually upload or enter the changes to the previously provided input mobile asset data. In some embodiments, certain input mobile asset data (e.g., asset profile, region ID) may be modified only by an administrator. In some other embodiments, certain input mobile asset data (e.g., date) may automatically adjust and may only be modified if the mobile asset representative is determining prime location for a future date and not the present date.

For example, Mobile asset ABC sells handmade pottery from local artists. An employee, Employee A, is scheduled to work today on Mobile asset ABC. In the morning, Employee A utilizes the location prediction program 110a, 110b to determine prime locations and halting points in each prime location for the day. When Employee A starts the location prediction program 110a, 110b, the location prediction program 110a, 110b asks Employee A whether there are any changes the input mobile asset data. Employee A clicks the “No” button, since the location prediction program 110a, 110b automatically changed the date to the present day. As such, the Mobile asset ABC will be located in northeast Queens, N.Y. today.

Next, at 304, input user data is retrieved. Input user data (i.e., data associated with the user 206) may be retrieved automatically, manually with input from the user 206 via a graphical user interface (GUI), or application downloaded onto the user device 208.

Utilizing a software program 108 on the user device 208, the input user data may be retrieved as input into the location prediction program 110a, 110b via the communication network 116. The location prediction program 110a, 110b may simultaneously retrieve the input user data at 304 and retrieve the input mobile asset data at 302. The input user data may, for example, include past user trajectory data (e.g., movement of the user 206 within a certain period of time, or physical location of the user) and various dimensions associated with the interests of the user 206 (i.e., user interests or user features).

In an embodiment, the location prediction program 110a, 110b may receive consent, via an opt-in or opt-out feature, of the corresponding user 206 prior to commencing the user data retrieval associated with the user 206. In some embodiments, the location prediction program 110a, 110b may notify (e.g., via dialog box) the user 206 when user data retrieval begins. As such, the user 206 may have the option of temporarily or permanently prohibiting the user data retrieval by the location prediction program 110a, 110b.

In another embodiment, the location prediction program 110a, 110b may retrieve the input mobile asset data at 302 and retrieve the input user data at 304 consecutively. For example, the location prediction program 110a, 110b may retrieve the input mobile asset data at 302 before retrieving the input user data at 304, or the location prediction program 110a, 110b may retrieve the input user data at 304 before retrieving the input mobile asset data at 302.

Continuing the previous example, the location prediction program 110a, 110b simultaneously accesses the input user data associated with millions of the users 206, who have selected the opt-in feature for the location prediction program 110a, 110b to retrieve data on the user 206. For many of the users 206, the user device 208 is the smartphone or a wearable smart device, such as a smart watch, that each user 206 carries with them throughout the course of the day.

Next, at 306, user profiled flow routes are predicted. The location prediction program 110a, 110b may leverage various dimensions to predict the user profiled flow routes (e.g., travel routes, or changes to the physical location of the user 206 based on the user device 208). The location prediction program 110a, 110b may utilize a search engine to search the Internet and perform a social network analysis to track (or trace) the user home and work locations based on time and the predicted daily patterns associated with each user 206 (i.e., regular user movement patterns from tracking home and/or work locations from social media). The location prediction program 110a, 110b may then utilize the software program 108 on the user device 208 to determine the user routes between home and work locations to predict the daily route patterns.

In at least one embodiment, the location prediction program 110a, 110b may utilize alternative or additional data sources, such as foot traffic data providers and vehicle traffic data providers that provide data based on mobile device movement, to predict regular user movement patterns. The foot traffic data providers and vehicle traffic data providers may utilize an application on the user device 208 in which user data associated with the daily patterns or locations of the user 206 may be collected, monitored, and/or stored. The location prediction program 110a, 110b may utilize these data sources to track each user 206, and by analyzing the data collected by these data sources, the location prediction program 110a, 110b may predict the daily patterns of each user 206.

In at least one embodiment, the location prediction program 110a, 110b may predict the day-to-day life movement data pattern associated with each user 206, which may include the physical location and user movements over the period of multiple days. The location prediction program 110a, 110b may then include tracking additional activities performed by each user 206 on a frequent basis, for example, grocery shopping, dropping off and/or picking up children from school or daycare, visiting family members, going for lunch, going for dinner, buying coffee and/or gas in route to work, going to the gym or sport related activity and/or event. In at least one embodiment, the location prediction program 110a, 110b may identify the prime location (i.e., best location), or point of interests (POIs) associated with each mobile asset 202 based on user profiles. In such an embodiment, each user 206 may be associated with a user profile that collects data associated with user profiled flow routes. The user profile may be stored on the user profile database (e.g., database 114), and accessed or updated on a regular basis, or as warranted.

Additionally, the location prediction program 110a, 110b may predict the events based on flow patterns. The location prediction program 110a, 110b may utilize a crawler to crawl social media and identify various public events or activities occurring in the geographical region (e.g., region ID). By utilizing the search engine to perform social network analysis, the location prediction program 110a, 110b may determine the users 206 who may attend each public event or activity. In at least one embodiment, the location prediction program 110a, 110b may retrieve the user profile, from the user profile database, associated with the type of users 206 who would attend each public event or activity.

In at least one embodiment, the location prediction program 110a, 110b may extract the user profile of each person who expressed interest in attending or learning more about the public event or activity. In some embodiments, the location prediction program 110a, 110b may also extract the user profile of each person who previously attended a similar or the same event within a current period of time (e.g., default is 10 years or less).

In at least one embodiment, the location prediction program 110a, 110b may utilize event data providers to extract the events happening in the geographical region.

Then, based on the data generated on the predicted daily patterns of the user 206 and the predicted events based on flow patterns, the location prediction program 110a, 110b may predict a runtime user inward/outward flow (i.e., spatio-temporal user flow for various user profiles) between routes in the geographical region, which includes the movement of a person or people from one location to another, within a period of time. The location prediction program 110a, 110b may model the movement of people based on user profiles (e.g., user interests) associated with people involved in the movement (i.e., spatio-temporal user flow profiling) within a period of time.

Continuing the previous example, the location prediction program 110a, 110b utilizes social networks and foot traffic providers to determine the regular user movements in northeast Queens, N.Y. today, which is a Saturday. Then, the location prediction program 110a, 110b utilizes a search engine to crawl through the internet and social networks, and determines that there is a Night Food Market located on Main Street from 5 PM to midnight and Farmers Market located on Springfield Boulevard from 10 AM to 4 PM in the northeast Queens area. Each event attracts more one million users 206 daily, and on the weekends, especially on Saturdays, the Night Food Market attracts more than two million users 206 since the market includes performances from local musicians and bands. Each event, however, is located more than 10 miles away from each other, and the traffic patterns in northeast Queens are generally heavy on Saturdays. The location prediction program 110a, 110b utilizes this data to predict the user flows for northeast Queens.

Then, at 308, the asset profile is correlated with spatio-temporal user flows. Based on the user profiled flows, the location prediction program 110a, 110b may derive Top-K routes having a high match between the user flow profiles and the asset profile. Every asset profile may be captured as one or more user features that enables the matching of the asset profile with the spatio-temporal user flows by the location prediction program 110a, 110b. Based on the user flows associated with the one or more user features, the location prediction program 110a, 110b may calculate a score, as a percentage (e.g., normalized quantity ranging from 0-100%), associated with whether the user flows match with the asset profile. For example, if the Asset Profile A includes a description of the store as an apparel store that sells clothing items from various fashion brands, then matching user features could be the “number of times a user 206 travelled to the apparel store”, “brands used by the user 206,” and “how much the user 206 spends on apparel.” The user flows whose profiles have a high number of visits to apparel stores, use brands that are sold at the store, and/or have spent a significant amount of money and/or time at the store will have a high match. Since User A frequently shops at the store associated with Asset Profile A, the location prediction program 110a, 110b calculates a high score of 95% match (i.e., matching score) to Asset Profile A. However, User B rarely uses the brands sold at that store, User C travelled to the store on two occasions with a friend, and User D never spent any money or time in the store. Therefore, the location prediction program 110a, 110b calculates a low matching score of 25% for User B, a low matching score of 35% for User C, and a low matching score of 10% for User D.

In at least one embodiment, the location prediction program 110a, 110b may calculate the score (i.e., matching score) as a normalized quantity (e.g., ranging from 0-1, 0-10, 0-100).

In at least one embodiment, to determine whether the matching score is high or low, the location prediction program 110a, 110b may compare the score to a threshold level (e.g., 50% out of 100%, 0.5 out of 1, 5 out of 10, 50 out of 100). If the matching score is equal to or higher than the threshold level, then the matching score may be deemed high. If, however, the matching score is less than the threshold level, then the matching score may be deemed low. In some embodiments, an administrator may configure the settings to change the threshold level to a different value.

Additionally, the location prediction program 110a, 110b may sort the matching scores. Based on the user flows with a high match to the asset profile, the location prediction program 110a, 110b may select the Top-K routes in which the mobile asset may encounter more users 206 with high matching scores.

Continuing the previous example, the location prediction program 110a, 110b compares the asset profile with the multiple user profiled flows. The location prediction program 110a, 110b compares the user features of the users 206 with the asset profile associated with Mobile asset ABC, and searches for users 206 with certain user features, such as collects handmade pottery, visited stores that sell handmade pottery, or have expressed interest in, willingness to purchase, or have purchased handmade pottery, as well as users 206 who have visited the Mobile asset ABC, who follow the Mobile asset ABC on social media, who have purchased goods from the Mobile asset ABC, or who have expressed interest in purchasing locally sourced goods. The location prediction program 110a, 110b identifies 1,200,957 different users who are attending the Night Food Market and/or the Farmers Market, and who include one or more user features, and calculates matching scores for each. The calculated matching scores for each of the 1,200,957 users range from 30% to 95%. The location prediction program 110a, 110b then sorts the matching scores and determines that a majority of the users 206 are above 75%. Therefore, the location prediction program 110a, 110b determines that a majority of the users 206 attending either the Night Food Market or the Farmers Market have an interest in locally sourced or locally based products and/or brands, and therefore, these users 206 will be interested in the handmade pottery sold by the Mobile asset ABC. The location prediction program 110a, 110b may identify several Top-K routes between the Night Food Market and the Farmers Market that Mobile asset ABC can use to travel between the two events.

Then, at 310, travel path(s) and halting point(s) are determined. The location prediction program 110a, 110b may then leverage aerial image segmentation on the derived Top-K routes to determine the appropriate spots (or points) in the routes in the geographical region. For a spot to be considered appropriate, the location prediction program 110a, 110b may analyze whether adequate or spacious parking space is available for the mobile asset without hindering traffic in a prime location. The location prediction program 110a, 110b may then extract potential locations for parking the mobile asset(s) from satellite data partners.

In at least one embodiment, the location prediction program 110a, 110b may extract potential locations by utilizing map providers in addition to, or in lieu of, satellite data partners.

Additionally, the location prediction program 110a, 110b may fuse the satellite data with the spatio-temporal user flow data to derive Top-K ranked locations in the geographical region (e.g., Region ID). The location prediction program 110a, 110b may then create clusters of the Top-K ranked locations based on the number of available mobile assets. Each mobile asset may then halt in a highly visible spot in one or more prime locations based on the cluster formation.

Continuing the previous example, the location prediction program 110a, 110b then analyzes the possible halting points that would be available for Mobile asset ABC. Since Mobile asset ABC is approximately 14 feet length, which is in the small range for mobile assets, the location prediction program 110a, 110b determines that Mobile asset ABC has more than seven different halting points at each of the two prime locations for the Night Food Market, and approximately four different halting points at each of the three prime locations for the Farmers Market. The location prediction program 110a, 110b further determines the travel paths to and from each event, and between each prime location. The location prediction program 110a, 110b selects travel paths with moderate traffic patterns and high volume of foot traffic by pedestrians and other passers-by.

Then, at 312, the travel path(s) and halting point(s) are presented. The location prediction program 110a, 110b may present, as an output, the travel path(s) for each of the mobile assets and the halting location(s) or point(s) at various time points (e.g., range of time) in the given geographical region (e.g., region ID) and date.

In at least one embodiment, the location prediction program 110a, 110b may be integrated to another software program 108 on the client device which provides global positioning (GPS) for the mobile asset. Based on the data transmitted from the location prediction program 110a, 110b, via the communication network 116, the GPS program may display a map with each potential travel path highlighted for the mobile asset.

In some embodiments, the location prediction program 110a, 110b may rank the potential travel paths and halting points which are transmitted to the GPS program. Therefore, the mobile asset representative may utilize the GPS program located on the client device to indicate the rank of a particular potential travel path with a different color (e.g., highest ranked travel path highlighted in yellow, the second highest ranked travel path highlighted in green).

In at least one embodiment, the location prediction program 110a, 110b may provide a list of the potential travel paths, with a corresponding link, sorted based on rank (e.g., with the highest travel path listed first, then the second highest, etc.). When the mobile asset representative clicks on the link associated with a particular travel path listed by the location prediction program 110a, 110b, the location prediction program 110a, 110b may transmit that data to the GPS program, and the GPS program may upload a map with the selected travel path to be displayed to the mobile asset representative on the client device.

In at least one embodiment, the location prediction program 110a, 110b may provide data associated with the halting locations or spots at various time points to the mobile asset representative. In at least one embodiment, the location prediction program 110a, 110b may present, to the mobile asset representative, the halting points in the form of a list, an itinerary or a schedule based on the time for each of the potential travel paths. Therefore, the mobile asset representative may receive a timeline in which the mobile asset may be located at a particular halting point. In some embodiments, the location prediction program 110a, 110b may transmit data associated with the halting point(s) to the GPS program via the communication network 116. As such, the mobile asset representative may utilize the GPS program to receive a view (e.g., aerial view, street view or map view) of the various halting points for the mobile asset.

Continuing the previous example, the location prediction program 110a, 110b presents the following itinerary to Employee A on each client device, namely the computer screen associated with the cashier for Mobile asset ABC and the navigation system associated with the Mobile asset ABC:

### 9:00 AM-9:45 AM—Travel Route 1 to Farmers Market

9:45 AM-4:30 PM—Use Halting point 2 on Springfield Boulevard located near the front entrance of the Famers Market

### 4:30 PM-5:00 PM—Travel Route 2 to Night Food Market

5:00 PM-10:00 PM—Use Halting point 7 on Main Street located near the side entrance/exit of the Night Food Market and across the street from the performance stage in which the bands and musicians perform from 7:00 PM to 9:00 PM
10:00 PM-10:15 PM—Travel Route 3 to overnight parking space for Mobile asset ABC.

When Employee A clicks on the different routes, such as Route 1, 2 and 3, and halting points, as such Halting points 2 and 7, the location prediction program 110a, 110b will transmit the request to a GPS and/or map system associated with Mobile asset ABC and the GPS and/or map system will present aerial and street views of the halting point and a map with the requested route.

In the present embodiment, the mobile asset representative may provide feedback to the location prediction program 110a, 110b associated with the presented travel paths and/or halting points. The location prediction program 110a, 110b may utilize the received feedback from a mobile asset representative (i.e., user feedback) to modify future predictions for the particular mobile asset or other similar mobile assets (e.g., similar based on size, services, type of customers).

The functionality of a computer may be improved by the location prediction program 110a, 110b because the location prediction program 110a, 110b may utilize spatio-temporal user flow profiling, instead of spatio-temporal user profiling. By profiling the spatio-temporal user flows based on dimensions related to user interests (i.e., user features) and past user trajectory data, and correlating these profiled user flows with the asset profile associated with the mobile asset, the location prediction program 110a, 110b may be able to determine or detect potential flow paths for routes in the geographical region. The location prediction program 110a, 110b further improves the visibility of the mobile asset and connects highly matched users 206 (e.g., consumers) with the mobile asset. The location prediction program 110a, 110b further fuses the potential flow path with aerial image segmentation inferences to discover halting points. The location prediction program 110a, 110b further, unlike traditional approaches, utilizes spatio-temporal inward/outward flow of users 206 and how spatio-temporal inward/outward flow matches with an asset profile for mobile asset location prediction.

It may be appreciated that FIGS. 2A, 2B and 3 provide only an illustration of one embodiment and do not imply any limitations with regard to how different embodiments may be implemented. Many modifications to the depicted embodiment(s) may be made based on design and implementation requirements.

FIG. 4 is a block diagram 900 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 4. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108 and the location prediction program 110a in client computer 102, and the location prediction program 110b in network server 112, may be stored on one or more computer-readable tangible storage devices 916 for execution by one or more processors 906 via one or more RAMs 908 (which typically include cache memory). In the embodiment illustrated in FIG. 4, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the location prediction program 110a, 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless Wi-Fi interface cards, or 3G or 4G wireless interface cards or other wired or wireless communication links. The software program 108 and the location prediction program 110a in client computer 102 and the location prediction program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the location prediction program 110a in client computer 102 and the location prediction program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

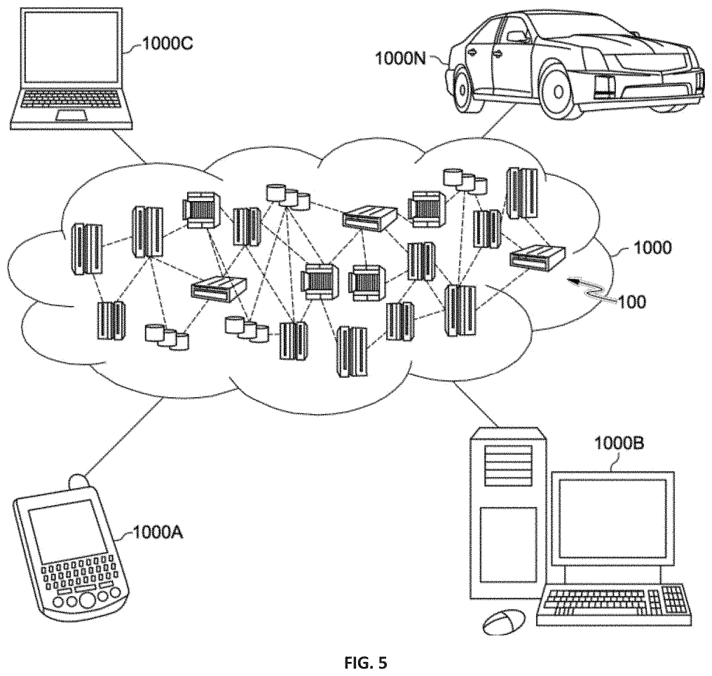

Referring now to FIG. 5, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 5 are intended to be illustrative only and that computing nodes 100 and cloud computing environment 1000 can communicate with any type of computerized device over any type of network and/or network addressable connection (e.g., using a web browser).

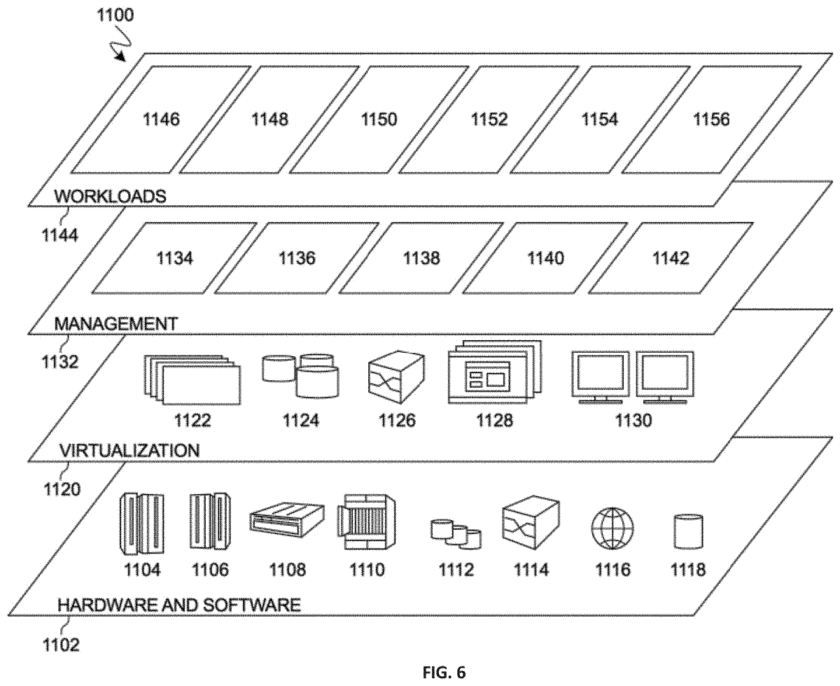

Referring now to FIG. 6, a set of functional abstraction layers 1100 provided by cloud computing environment 1000 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and location prediction 1156. A location prediction program 110a, 110b provides a way to predict a potential travel path with higher visible halting points for mobile assets.

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language, Python programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently, substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
retrieving a set of input data,
wherein the retrieved set of input data includes a set of input user data and a set of input mobile asset data,
wherein the retrieved set of input user data includes a set of past user trajectory data and a plurality of user interests;
predicting one or more spatio-temporal user profile flows based on the set of past user trajectory data and the plurality of user interests;
correlating the predicted one or more spatio-temporal user profile flows with one or more mobile assets; and
determining one or more potential travel paths in one or more routes associated with a geographical region for one or more mobile assets and one or more halting points for one or more mobile assets.

2. The method of claim 1, further comprising:
generating a spatio-temporal runtime profile,
wherein the generated spatio-temporal runtime profile matches between the one or more mobile assets and the predicted one or more spatio-temporal user profile flows in the one or more routes associated with the geographical region based on social medial analysis.

3. The method of claim 1, further comprising:
fusing the one or more potential travel paths with one or more aerial image segmentation inferences;
determining one or more halting points from the fused one or more potential travel paths and the corresponding one or more aerial image segmentation inferences; and
presenting, to the user, the determined one or more halting points and the one or more potential travel paths.

4. The method of claim 1, wherein predicting one or more spatio-temporal user profile flows based on a set of past user trajectory data, further comprises:
predicting a plurality of daily patterns associated with the user associated with the predicted one or more user profile flows;
predicting a plurality of events based on the predicted one or more user profile flows; and
predicting a runtime profile for user inward/outward flow between the one or more routes in the geographical region.

5. The method of claim 4, wherein predicting the plurality of events based on the predicted one or more user profile flows, further comprises:
extracting the geographical region based on data associated with one or more censuses, data associated with traffic patterns, and data associated with one or more survey;
extracting a plurality of public events based on data derived from one or more social networks; and
identifying a plurality of users as attendees to the identified plurality of public events based on data derived from one or more social networks.

6. The method of claim 4, wherein predicting the plurality of daily patterns associated with the user associated with the predicted one or more user profile flows, further comprises:
predicting a regular user movement pattern from tracking the home location and work location associated with the user based on one or more social networks; and
predicting a day-to-day life movement data pattern associated with the user.

7. The method of claim 3, wherein fusing the one or more potential travel paths with the one or more aerial image segmentation inferences, further comprises:
generating a plurality of Top-K ranked locations in the geographical region; and
creating a plurality of clusters of the Top-K ranked locations based on the number of available mobile assets.

8. The method of claim 1, wherein the retrieved set of input mobile asset data includes a region identification (ID), an asset profile associated with the one or more mobile assets, and a date.

9. The method of claim 1, further comprising:
presenting the determined one or more potential travel paths and the determined one or more halting points to the one or more asset devices associated with the one or more mobile assets.

10. A computer system for predicting one or more travel paths for one or more mobile assets, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
retrieving a set of input data,
wherein the retrieved set of input data includes a set of input user data and a set of input mobile asset data,
wherein the retrieved set of input user data includes a set of past user trajectory data and a plurality of user interests;
predicting one or more spatio-temporal user profile flows based on the set of past user trajectory data and the plurality of user interests;
correlating the predicted one or more spatio-temporal user profile flows with the one or more mobile assets; and
determining one or more potential travel paths in one or more routes associated with a geographical region for one or more mobile assets and one or more halting points for one or more mobile assets.

11. The computer system of claim 10, further comprising:
generating a spatio-temporal runtime profile,
wherein the generated spatio-temporal runtime profile matches between the one or more mobile assets and the predicted one or more spatio-temporal user profile flows in the one or more routes associated with the geographical region based on social medial analysis.

12. The computer system of claim 10, further comprising:
fusing the one or more potential travel paths with one or more aerial image segmentation inferences;
determining one or more halting points from the fused one or more potential travel paths and the corresponding one or more aerial image segmentation inferences; and
presenting, to the user, the determined one or more halting points and the one or more potential travel paths.

13. The computer system of claim 10, wherein predicting one or more spatio-temporal user profile flows based on a set of past user trajectory data, further comprises:
predicting a plurality of daily patterns associated with the user associated with the predicted one or more user profile flows;
predicting a plurality of events based on the predicted one or more user profile flows; and
predicting a runtime profile for user inward/outward flow between the one or more routes in the geographical region.

14. The computer system of claim 13, wherein predicting the plurality of events based on the predicted one or more user profile flows, further comprises:
extracting the geographical region based on data associated with one or more censuses, data associated with traffic patterns, and data associated with one or more survey;
extracting a plurality of public events based on data derived from one or more social networks; and
identifying a plurality of users as attendees to the identified plurality of public events based on data derived from one or more social networks.

15. The computer system of claim 13, wherein predicting the plurality of daily patterns associated with the user associated with the predicted one or more user profile flows, further comprises:
predicting a regular user movement pattern from tracking the home location and work location associated with the user based on one or more social networks; and
predicting a day-to-day life movement data pattern associated with the user.

16. The computer system of claim 12, wherein fusing the one or more potential travel paths with the one or more aerial image segmentation inferences, further comprises:
generating a plurality of Top-K ranked locations in the geographical region; and
creating a plurality of clusters of the Top-K ranked locations based on the number of available mobile assets.

17. The computer system of claim 10, wherein the retrieved set of input mobile asset data includes a region identification (ID), an asset profile associated with the one or more mobile assets, and a date.

18. A computer program product for predicting one or more travel paths for one or more mobile assets, the computer program product comprising a computer-readable storage medium having program instructions embodied therewith, wherein the computer readable storage medium is not transitory signal per se, the program instructions executable by a processor to cause the processor to perform a method comprising:
retrieving a set of input data,
wherein the retrieved set of input data includes a set of input user data and a set of input mobile asset data,
wherein the retrieved set of input user data includes a set of past user trajectory data and a plurality of user interests;
predicting one or more spatio-temporal user profile flows based on the set of past user trajectory data and the plurality of user interests;
correlating the predicted one or more spatio-temporal user profile flows with the one or more mobile assets; and
determining one or more potential travel paths in one or more routes associated with a geographical region for one or more mobile assets and one or more halting points for one or more mobile assets.

19. The computer program product of claim 18, further comprising:
generating a spatio-temporal runtime profile,
wherein the generated spatio-temporal runtime profile matches between the one or more mobile assets and the predicted one or more spatio-temporal user profile flows in the one or more routes associated with the geographical region based on social medial analysis.

20. The computer program product of claim 18, further comprising:
fusing the one or more potential travel paths with one or more aerial image segmentation inferences;
determining one or more halting points from the fused one or more potential travel paths and the corresponding one or more aerial image segmentation inferences; and
presenting, to the user, the determined one or more halting points and the one or more potential travel paths.
